(19) United States
(12) Patent Application Publication
(10) Pub. No.: US 2009/0040156 A1
(43) Pub. Date: Feb. 12, 2009

(54) DISPLAY DEVICE AND METHOD FOR DRIVING THE SAME

(76) Inventors: Bong-Ju Jun, Cheonan-si (KR); Bong-Im Park, Cheonan-si (KR); Hyoung-Rae Lee, Cheonan-si-do (KR); Jae-Won Jeong, Seoul (KR); Yong-Jun Choi, Cheonan-si (KR)

Correspondence Address: F. CHAU & ASSOCIATES, LLC, 130 WOODBURY ROAD, WOODBURY, NY, 11797, US

(21) Appl. No.: 12/131,991

(22) Filed: Jun. 3, 2008

(30) Foreign Application Priority Data
Aug. 8, 2007 (KR) 10-2007-0079302

(51) Int. Cl. G09G 3/36

(52) U.S. Cl. 345/87

(57) ABSTRACT

A display device and a method for driving the same, in which the display device includes a storage unit for storing a plurality of reference gradation code data corresponding to a plurality of gradations, and some of variable gradation code data corresponding to some of the gradation points of the plurality of gradations; a signal controller for converting gradations of original pixel data into gradation code signals of different levels using the plurality of reference gradation code data or both the plurality of reference gradation code data and the some variable gradation code data according to an operation mode; a data driver for converting the gradation code signal into an analog pixel data signal; and an image display unit for displaying an image according to the pixel data signal. The original pixel data are converted into gradation code signals of different levels according to an image display mode, thereby preventing luminance degradation and flicker generation due to the image display mode. Only the reference gradation code data and some of the variable gradation code data are stored in the memory to thereby reduce the amount of data stored in the memory, so that manufacturing costs of display devices caused by additional memories can be reduced.

This application claims priority to Korean Patent application No. 10-2007-0079302, filed on Aug. 8, 2007 and all the benefits accruing therefrom under 35 U.S.C. 119, the contents of which are herein incorporated by reference in its entirety.

### BACKGROUND OF THE INVENTION

1. Technical Field

The present disclosure relates to a display device and a method for diving the same and, more particularly, to a display device having an improved luminance characteristic of a display screen and a method for driving the same.

2. Discussion of Related Art

In recent years, as portable electronic devices are required to have multimedia functions, the demand for flat display devices has rapidly increased. As one such flat display device, a thin film transistor-liquid crystal display (TFT-LCD) device has been widely used for portable electronic devices, because of its light weight and low power consumption.

A liquid crystal display device, however, has a lower response speed to moving images than a conventional cathode ray tube (CRT). That is, the conventional cathode ray tube displays an image signal in an impulse fashion, while the liquid crystal display device displays an image signal in a so-called hold fashion. Accordingly, the liquid crystal display device sometimes shows a motion blur when implementing a moving image. This is because the response speed of the liquid crystal is slower than the time period of one video frame. That is, a voltage (an image signal or data voltage) charged in the liquid crystal is held during one frame and a new voltage is applied in a next frame, thereby causing the motion blur on the screen.

In order to prevent the motion blur caused by the image hold display, recent liquid crystal display devices use an impulse approach, in which actual image data are applied in a certain section of one frame and black data are applied in the other sections. When the liquid crystal display device displays an image using the impulse approach, however, the image is not continuously displayed during one frame. Thereby luminance is degraded and a flicker phenomenon can occur.

### SUMMARY OF THE INVENTION

Accordingly, exemplary embodiments of the present invention provide a display device and a method for driving the same, in which luminance degradation and flicker generation can be prevented by changing a reference gradation value depending on an image display approach.

According to an exemplary embodiment of the present invention, there is provided a display device, including: a storage unit for storing a plurality of reference gradation code data corresponding to a plurality of gradations, and some variable gradation code data corresponding to some of the gradation points of the plurality of gradations; a signal controller for converting gradations of original pixel data into gradation code signals of different levels using the plurality of reference gradation code data or both the plurality of reference gradation code data and the some variable gradation code data according to an operation mode; a data driver for converting the gradation code signal into an analog pixel data signal; and an image display unit for displaying an image according to the pixel data signal.

The signal controller may include a data input unit for receiving the original pixel data; a gradation code conversion unit for converting the received original pixel data into the gradation code signal of a first or second level using the plurality of reference gradation code data and the some of the variable gradation code data according to the operation mode of the image display unit; and a data output unit for providing the gradation code signal of the first or second level to the data driver.

The reference gradation code data and the variable gradation code data may be selected from the same range of gradation code data values; and for the original pixel data having the same gradation, a gradation code data value of the gradation code signal of the second level may be greater than that of the gradation code signal of the first level.

The gradation code conversion unit may include a code signal converter for outputting the reference gradation code data corresponding to the gradation of the original pixel data among the plurality of reference gradation code data, or generating the variable gradation code data corresponding to the gradation of the original pixel data using the plurality of reference gradation code data and some of the variable gradation code data, according to the operation mode of the image display unit; and a gradation code signal generator for outputting the reference gradation code data or the variable gradation code data as the gradation code signal of the first or second level.

The gradation code conversion unit may include a gradation code generator for converting the gradation of the original pixel data into the reference gradation code data; and a code data changer for outputting the reference gradation code data as the gradation code signal of the first level, or converting the gradation code signal of the first level into the gradation code signal of the second level based on the variable gradation code data and outputting the gradation code signal of the second level, according to the operation mode of the image display unit.

The gradation code conversion unit may include a normal code signal generator for outputting the reference gradation code data as the gradation code signal of the first level according to the operation mode of the image display unit, the reference gradation code data corresponding to the gradation of the original pixel data among the plurality of reference gradation code data; and a modified code signal generator for generating the variable gradation code data corresponding to the gradation of the original pixel data using the plurality of reference gradation code data and some of the variable gradation code data according to the operation mode of the image display unit, and outputting the generated variable gradation code data as the gradation code signal of the second level.

The operation mode of the image display unit may be a normal operation mode or an impulse operation mode; and in the impulse operation mode, the signal controller may provide a portion of a pixel data signal corresponding to black of a predetermined percentage in one frame section.

For the gradation of the same original pixel data, the level of the gradation code signal in the impulse operation mode may be higher than that in the normal operation mode.

As the percentage of the pixel data signal corresponding to black applied in one frame section increases, the level of the gradation code signal may increase.

The storage unit and the signal controller may be provided in a single chip.

The data driver may include a latch for latching the gradation code signal; a gradation voltage generator for generating a plurality of gradation voltages; and a digital-to-analog converter for converting the gradation code signal into the analog pixel data signal using the plurality of gradation voltages.

According to an exemplary embodiment of the present invention, there is provided a method for driving a display device, including: storing a plurality of reference gradation code data corresponding to a plurality of gradations and some variable gradation code data corresponding to some of the gradation points of the plurality of gradations; receiving original pixel data; determining whether the display device is in a normal operation mode or an impulse operation mode; and if the display device is in the normal operation mode, outputting the reference gradation code data as a gradation code signal of a first level, the reference gradation code data corresponding to the gradation of the original pixel data among the plurality of reference gradation code data, and if the display device is in the impulse operation mode, generating variable gradation code data corresponding to the gradation of the original pixel data using the plurality of reference gradation code data and the some of the variable gradation code data and outputting the generated variable gradation code data as the gradation code signal of a second level; and converting the gradation code signal of the first or second level into a pixel data signal.

The impulse operation mode may be divided into a plurality of levels depending on a percentage of black data in one frame; a plurality of variable gradation code data groups may be stored to correspond to the plurality of levels of the impulse operation mode, some of the variable gradation code data being stored in the variable gradation code data groups; and when the impulse operation mode of a corresponding one of the levels is selected, a corresponding one of the variable gradation code data groups may be used.

Storing some of the variable gradation code data may include generating the variable gradation code data corresponding to the plurality of gradations; selecting some of the gradation points of the plurality of gradations; and storing the selected gradation points and the selected variable gradation code data corresponding thereto.

Generating the variable gradation code data corresponding to the gradation of the original pixel data using the plurality of reference gradation code data and some of the variable gradation code data may include comparing the gradation of the original pixel data with some of the stored gradation points; and using the stored variable gradation code data corresponding to the gradation of the original pixel data as it is if the gradation of the original pixel data is the same as the gradation points, and generating new variable gradation code data if the gradation of the original pixel data is not the same as the gradation points, wherein generating the new variable gradation code data may include setting two upper and lower gradation points adjacent the gradation of the original pixel data; and calculating the new variable gradation code data using the two variable gradation code data corresponding to the two adjacent gradation points, two reference gradation code data corresponding to the two adjacent gradation points, and reference gradation code data corresponding to the gradation of the original pixel data.

The new variable gradation code data may be calculated by interpolation.

### BRIEF DESCRIPTION OF THE DRAWINGS

Exemplary embodiments of the present invention can be understood in more detail from the following descriptions taken in conjunction with the accompanying drawings, in which:

FIG. 1 is a block diagram of a display device according to an exemplary embodiment of the present invention;

FIG. 2 is a block diagram illustrating a signal controller according to this exemplary embodiment;

FIG. 3 is a block diagram illustrating a gradation code conversion unit according to this exemplary embodiment;

FIGS. 4 and 5 are block diagrams illustrating a gradation code conversion unit according to an exemplary embodiment;

FIG. 6 is a block diagram illustrating a data driver according to this exemplary embodiment;

FIG. 7 is a graph illustrating a change in gradation code data groups in an impulse operation;

FIG. 8 is a graph illustrating gradation code data groups for a normal operation and an impulse operation;

FIG. 9 is an enlarged view of an area K of FIG. 8;

FIG. 10 is a schematic diagram for calculating variable gradation code data that is not stored in a storage unit; and

FIG. 11 is a flow chart illustrating the operation of the display device according to this exemplary embodiment.

### DETAILED DESCRIPTION OF EXEMPLARY EMBODIMENTS

Hereinafter, exemplary embodiments of the present invention will be described in detail with reference to the accompanying drawings. The present invention is not limited to the exemplary embodiments disclosed below however, but may be implemented into different forms. These exemplary embodiments are provided only for illustrative purposes and for full understanding of the scope of the present invention by those of ordinary skill in the art.

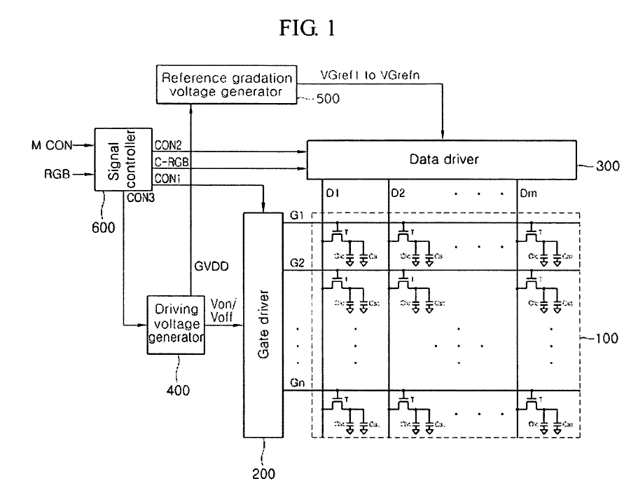

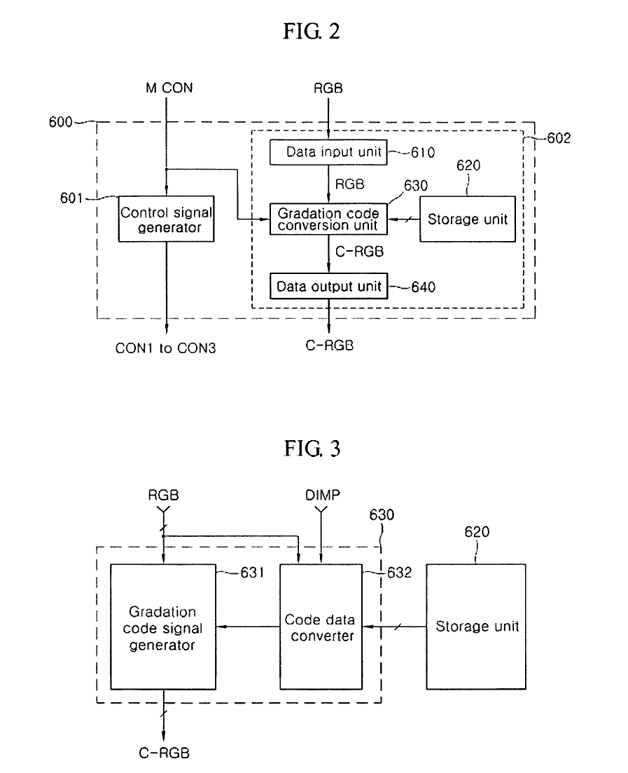

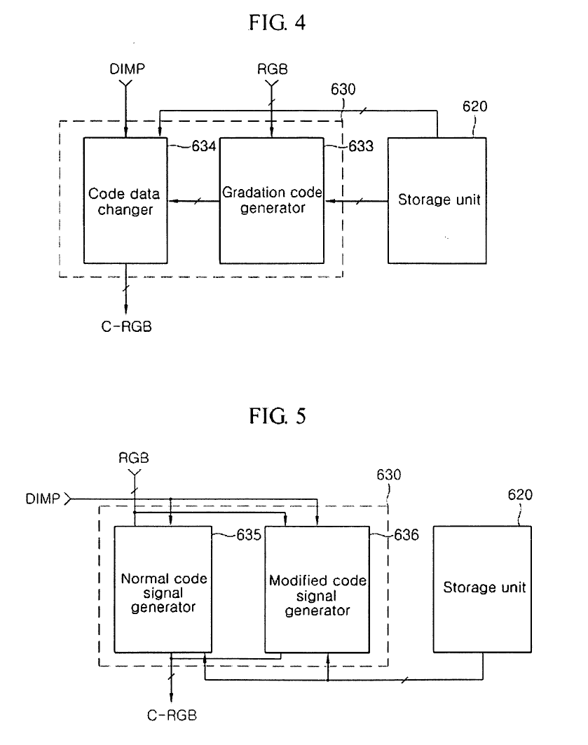

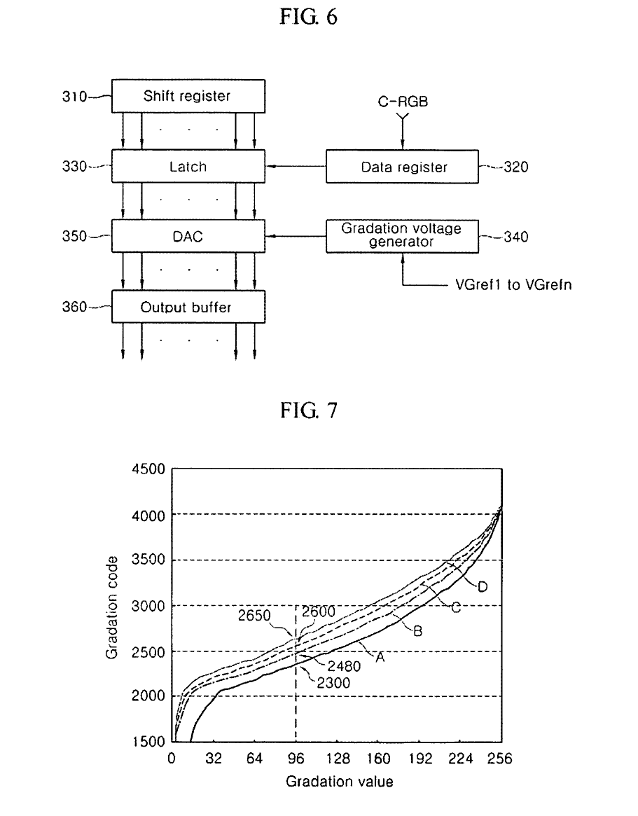

FIG. 1 is a block diagram of a display device according to an exemplary embodiment of the present invention. FIG. 2 is a block diagram illustrating a signal controller according to this exemplary embodiment. FIG. 3 is a block diagram illustrating a gradation code conversion unit according to this exemplary embodiment. FIGS. 4 and 5 are block diagrams illustrating gradation code conversion units according to exemplary embodiments of the present invention. FIG. 6 is a block diagram illustrating a data driver according to this exemplary embodiment.

Referring to FIGS. 1 to 6, a display device according to an exemplary embodiment includes an image display unit 100, a gate driver 200, a data driver 300, a driving voltage generator 400, a reference gradation voltage generator 500, and a signal controller 600.

The image display unit 100 includes a plurality of gate lines G1 to Gn extending in one direction, and a plurality of data lines D1 to Dm extending in another direction intersecting the gate lines G1 to Gn. The image display unit 100 further includes a plurality of pixels connected to the gate lines G1 to Gn and the data lines D1 to Dm. The plurality of pixels are arranged in the image display unit 100 in a matrix pattern. Each pixel includes a thin-film transistor T, a storage capacitor Cst, and a liquid crystal capacitor Clc. The plurality of pixels display red (R), green (G), and blue (B) colors. The image display unit 100 displays all natural colors by combining red (R), green (G), and blue (B) pixels. The thin-film transistors T may be manufactured through a low-temperature poly silicon process. The thin-film transistors T are driven by gate turn-on voltages applied to the gate lines G1 to Gn and provide pixel data signals of the data lines D1 to Dm to the liquid crystal capacitors Clc.

The image display unit 100 is formed within a display panel, although not shown in FIG. 1. The display panel includes upper and lower transparent substrates. Specifically, the lower substrate of the display panel is provided with the thin-film transistors T, the gate lines G1 to Gn, the data lines D1 to Dm, and pixel electrodes for the liquid crystal capacitors Clc of the image display unit 100. The upper substrate is provided with a light shield pattern, for example, a black matrix, color filters, and a common electrode for the liquid crystal capacitors Clc. At this time, the light shield pattern may be formed over an entire area excluding a portion of the image display unit 100. A liquid crystal layer is provided between the upper and lower substrates.

A controller including the gate driver 200, the data driver 300, the driving voltage generator 400, the reference gradation voltage generator 500, and the signal controller 600 is provided outside of the image display unit 100 and is not shown in FIG. 1.

The controller supplies a driving signal to the image display unit 100, so that the image display unit 100 displays an image using external light. The controller includes various circuit elements, including transistors. In order to reduce a manufacturing cost of the display device including the controller, some of the above elements in the controller can be integrally fabricated on the display panel when manufacturing the image display unit 100. In such a case, the other elements in the controller may be fabricated in the form of a separate IC chip(s), that is, an integrated single chip or a plurality of chips separated from each other.

The signal controller 600 receives an input image signal RGB and an input control signal MCON to control displaying the input image signal RGB from an external graphic controller (not shown). The signal controller 600 also receives an external clock signal. The input image signal RGB includes original pixel data, that is R, G, and B data. The input control signal MCON includes a vertical synchronization signal, a horizontal synchronization signal a main clock, a data enable signal and a driving signal that is, a mode select signal.

In this exemplary embodiment, the signal controller 600 processes the input image signal according to an operating condition of the image display unit 100. The signal controller 600 generates a digitalized gradation code signal C-RGB of various levels for one gradation value of the input image signal RGB in response to the mode select signal. That is, the signal controller 600 generates a gradation code signal C-RGB of a normal level in a normal operation that is not an impulse operation. In the impulse operation, however, the signal controller 600 generates a plurality of changed gradation code signals C-RGB depending on levels of the driving signal. For example, in response to the input image signal RGB having the same gradation, the signal controller 600 generates a reference gradation code signal C-RGB in the normal operation and a changed gradation code signal C-RGB having a value greater than the reference gradation code signal C-RGB in the impulse operation. The signal controller 600 provides the generated gradation code signals C-RGB to the data driver 300.

The signal controller 600 also generates a plurality of control signals CON1, CON2, and CON3 including a gate control signal CON1 and a data control signal CON2. The signal controller 600 sends the gate control signal CON1 to the gate driver 200 and the data control signal CON2 to the data driver 300. In this exemplary embodiment, the gate control signal CON1 includes a vertical synchronization start signal indicating output initiation of the gate turn-on voltage Von, a gate clock signal, and an output enable signal. The data control signal CON2 includes a synchronization start signal indicating, transfer initiation of the pixel data signal, a load signal instructing application of a data voltage to the data line, and a data clock signal. The data control signal CON2 may further include an inversion signal for inverting the polarity of a gradation voltage with respect to a common voltage.

In this exemplary embodiment, the signal controller 600 is fabricated as an IC Chip and mounted on a printed circuit board (not shown) that is electrically connected to the display panel. Although not shown, the signal controller 600 is electrically connected with the gate driver 200 via a flexible printed circuit board that is connected with the printed circuit board.

The driving-voltage generator 400 generates a variety of driving voltages required for driving the display device using an external power input from an external power supply (not shown). The driving-voltage generator 400 generates a reference voltage GVDD, the gate turn-on voltage Von, a gate turn-off voltage Voff, and the common voltage. In response to the control signal CON3 from the signal controller 600, the driving-voltage generator 400 applies the gate turn-on voltage Von and the gate turn-off voltage Voff to the gate driver 200. The driving-voltage generator 400 also applies the reference voltage GVDD to the reference gradation voltage generator 500 and the common voltage to the image display unit 100.

The aforementioned gate driver 200 sequentially applies the gate turn on/off voltages Von/Voff from the driving-voltage generator 400 to the gate lines G1 to Gn in response to the control signal CON1. Accordingly, the thin-film transistor T to which the pixel data signal is to be applied can be controlled. In this exemplary embodiment, the gate driver is fabricated in an edge area of the display panel at the time when the image display unit 100 is manufactured. The gate driver 200 includes a plurality of stages respectively connected to the gate lines G1 to Gn of the image display unit 100. The gate driver 200 sequentially supplies the gate turn-on voltage to the gate lines G1 to Gn via the plurality of stages. Of course, the present invention is not limited thereto, but in this exemplary embodiment the gate driver 200 may be fabricated as an IC chip and mounted on the printed circuit board having the signal controller 600 mounted thereon. Alternatively, the gate driver 200 may be mounted in the edge area of the display panel.

The aforementioned reference gradation voltage generator 500 generates a plurality of reference gradation voltages VGref1 to VGrefn using the reference voltage GVDD. The reference gradation voltage generator 500 divides the reference voltage GVDD into the plurality of reference gradation voltages VGref1 to VGrefn through a string of resistors. The reference gradation voltage generator 500 provides the plurality of reference gradation voltages VGref1 to VGrefn to the data driver 300.

The data driver 300 converts the gradation code signal C-RGB into an analog pixel data signal using the reference gradation voltages VGref1 to VGrefn. The data driver 300 applies the converted pixel data signal to corresponding ones of the data lines D1 to Dm.

Hereinafter, the signal controller 600 will be described in greater detail with reference to FIG. 2.

The signal controller 600 includes a control signal generator 601 and a data processor 602.

The control signal generator 601 generates the plurality of control signals CON1, CON2, and CON3 for driving the display device on the basis of the input control signal MCON. The control signal generator 601 generates the gate control signal CON1 to control driving the gate driver 200, the data control signal CON2 to control driving the data driver 300, and the driving voltage control signal CON3 to control driving the driving voltage generator 400.

The data processor 602 converts the original pixel data RGB into the gradation code signal C-RGB, and provides the gradation code signal C-RGB to the data driver 300. The original pixel data RGB, which is applied to the data processor 602, includes original red, green, and blue pixel data. The data processor 602 converts the original red, green, and blue pixel data into gradation code signals, respectively, and provides the gradation code signals to the data driver 300. Because the original red, green, and blue pixel data are all signal-converted in the same way, only conversion of one of the original pixel data will be described in this exemplary embodiment.

In this exemplary embodiment, the level of the gradation code signal C-RGB is changed variously depending on one of the driving signals of first to n-th levels applied to the data processor 602. That is, in this exemplary embodiment, the level of the gradation code signal C-RGB converted from the original pixel data is changed according to an operation mode of the display device, which makes it possible for the display device to have uniform luminance irrespective of the operation mode of the display device.

The display device of this exemplary embodiment has a variety of operation modes. The operation modes include a normal operation mode and an impulse operation mode. In the case of the impulse operation mode, the luminance of the display device becomes lowered as black data are applied. Accordingly, different gradation code data groups must be used for the respective operation modes in order to minimize the luminance difference between the normal operation mode and the impulse operation mode. The gradation code data group includes gradation code data corresponding to each gradation. In a case where the impulse operation mode is divided into sub modes, a number of gradation code data groups are required. The division of the impulse operation mode depends on a percentage of the black data in one flame. For example, cases where percentages of the black data in one frame are 10%, 30%, and 50% are defined as first to third impulse operation modes, respectively. The first to third impulse operation modes use different gradation code data groups.

FIG. 7 is a graph illustrating a change in the gradation code data groups in the impulse operation mode.

In the normal operation mode, a gradation code data group, as indicated by a line A on the graph of FIG. 7, is used for respective gradations which in this example is 256 gradations. In this exemplary embodiment, the gradation code data group used in the normal operation mode is referred to as a reference gradation code data group. In order to maintain the same luminance as the normal operation mode, however, a gradation code data group as indicated by a line B is used in the first impulse operation mode, including black data of 10% in one frame, a gradation code data group as indicated by a line C is used in the second impulse operation mode, including black data of 30% in one frame, and a gradation code data group as indicated by a line D is used in the third impulse operation mode, including black data of 50% in one frame. In this exemplary embodiment, the gradation code data groups used in the impulse operation modes are referred to as variable gradation code data groups. The variable gradation code data groups include gradation code data obtained beforehand through several experiments or simulations.

Thus, it can be seen that the gradation code data in the gradation code data groups corresponding to the same gradation differ from each other depending on the operation modes. For example, as shown in FIG. 7, when the original pixel data RGB has a gradation value of 96, the gradation code data is about 2300 in the normal operation mode. The gradation code data of the same gradation value of 96 is about 2480, however, in the first impulse operation mode. In addition, the gradation code data is about 2600 in the second impulse operation mode, and the gradation code data is about 2650 in the third impulse operation mode. Thus, the increasing percentage of the black data in one frame leads to an increase in the gradation code data.

In this exemplary embodiment shown in FIG. 2, the data processor 602 outputs the gradation code data of the corresponding gradation code data group as the gradation code signal C-RGB. Accordingly, even though the pixel data having the same gradation value is applied to the data processor 602, different gradation code signals C-RGB are output depending on the operation modes of the display device.

The data driver 300 of FIG. 1 provides the gradation voltage corresponding to the gradation code signal C-RGB to the data lines D1 to Dm as the pixel data signal. Thus, the gradation code signal of the input original pixel data RGB is changed depending on the operation mode of the display device to prevent luminance degradation in the impulse operation mode.

One of the driving signals of the first to n-th levels is selectively provided to the data processor 602 depending on the operation modes of the display device. That is, in the normal mode, the driving signal of the first level is provided to the data processor 602. Accordingly, the data processor 602 outputs the gradation code signal C-RGB of the first level. In the impulse operation mode, one of the driving signals of the second to n-th levels is provided to the data processor 602 depending on an amount of the black data. Accordingly, the data processor 602 outputs one of the gradation code signals C-RGB of the second to n-th levels.

In this exemplary embodiment, the first to n-th levels of the driving signal are selected by a user. For example, when the user selects the normal operation mode in order to view a still image, the driving signal of the first level is provided to the data processor 602. When the user selects the impulse mode in order to view a moving image, one of the driving signals of the second to n-th levels is provided to the data processor 602 depending on the percentage of the black data in one frame.

The operation of the signal controller 600 of the display device having the normal operation mode and one impulse operation mode, in which only the first level driving signal and the second level driving signal are used, will be described below.

As shown in FIG. 2, the data processor 602 includes a data input unit 610, a gradation code conversion unit 630, a data output unit 640, and a storage unit 620.

The data input unit 610 receives original pixel data RGB from an external device, for example, a graphic controller (not shown). At this time, the data input unit 610 receives the original data in a low voltage differential signal manner. The data input unit 610 provides the received original pixel data RGB to the gradation code conversion unit 630. In this case, the data input unit 610 analyzes a gradation level for the original pixel data RGB.

The storage unit 620 stores a reference gradation code data group used in the normal operation. That is, the storage unit 620 stores reference gradation code data for all the gradations. For example, for 256 gradations, 256 reference gradation code data corresponding to the 256 gradations are stored in the storage unit 620. On the other hand, the storage unit 620 stores only some of a plurality of variable gradation code data in a variable gradation code data group used in the impulse operation. For example, seventeen gradation points, that is, gradations of 0, 16, 32, 48, 64, 80, 96, 112, 128, 144, 160, 176, 192, 208, 224, 240, and 256, of the 256 gradations are set, and variable gradation code data corresponding to the seventeen set gradation points are selectively stored in the storage unit 620. The stored variable gradation code data are referred to as point data, which form a point data group. It will be easily appreciated that the number of the gradation points is not limited thereto but may be smaller or greater than seventeen.

In this exemplary embodiment, the variable gradation code data group is a group of gradation code data values obtained through a plurality of experiments or simulations so that original pixel data having the same gradation result in the same luminance in the normal operation mode and the impulse operation mode, as described above. Accordingly, variable gradation code data for the respective gradations are first measured in the impulse operation mode in order to create the point data group. Variable gradation code data corresponding to some gradation points of the measured values are stored together with gradation values of the gradation points.

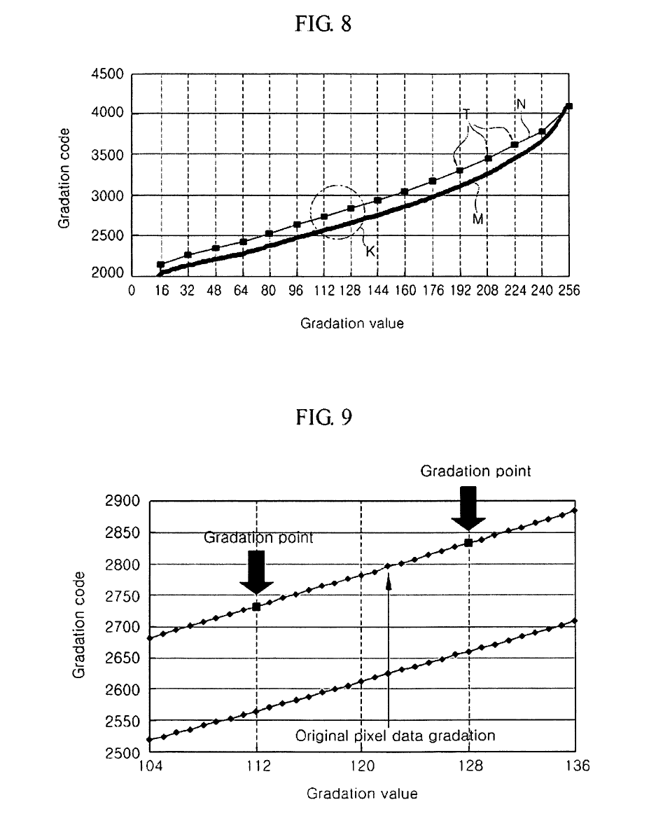

FIG. 8 is a graph illustrating gradation code data groups for normal operation and impulse operation. FIG. 9 is an enlarged view of an area K of FIG. 8.

A line M of FIG. 8 indicates a reference gradation code data group used in normal operation, wherein all gradation code data values corresponding to the 256 gradations are stored in the storage unit 620. A line N indicates a variable gradation code data group used in impulse operation, wherein seventeen variable gradation code data values that is, point gradation code values, corresponding to seventeen gradations of the 256 gradations are stored in the storage unit 620. Rectangular points indicated as T in FIG. 8 on the line N represent the seventeen selected variable gradation code data.

The reference gradation code values and the point gradation code values are stored in the storage unit 620 in the form of a look up table (LUT). The storage unit 620 may be an electrically erasable and programmable read only memory (EEPROM).

The gradation code conversion unit 630 converts the original pixel data RGB into the gradation code signal C-RGB of the first or second level using the driving signal DIMP of a first or second level, the reference gradation code data group, and the point data group.

First, in the normal operation, that is, when the driving signal DIMP of the first level is applied, the gradation code conversion unit 630 extracts the reference gradation code data corresponding to the gradation value of the input original pixel data RGB from the reference gradation code data group stored in the storage unit 620, and outputs the extracted reference gradation code data as the gradation code signal C-RGB of the first level. For example, when original pixel data RGB having a gradation of 112 is applied, the gradation code conversion unit 630 outputs the gradation code data corresponding to the gradation of 112 in the reference gradation code data group stored in the storage unit 620, that is, a gradation code of 2565, as the gradation code signal C-RGB of the first level. When the original pixel data RGB having a gradation of 128 values is applied, the gradation code conversion unit 630 outputs a gradation code of 2650 corresponding to the gradation of 128 in the reference gradation code data group as the gradation code signal C-RGB of the first level. The reference gradation code data corresponding to the gradation of the original pixel data RGB input as above is output as the gradation code signal C-RGB of the first level.

In the impulse operation, that is, when the driving signal DIMP of the second level is applied, the gradation code conversion unit 630 outputs the variable gradation code data corresponding to the gradation value of the input original pixel data RGB as the gradation code signal C-RGB of the second level by using the reference gradation code data group and the point data group. In this case, when the gradation of the applied original pixel data RGB is the same as the stored gradation point, the corresponding variable gradation code data is output as the gradation code signal C-RGB of the second level. When the gradation of the applied original pixel data RGB is not the same as the gradation point, however, variable gradation code data corresponding to the gradation are calculated using interpolation. For example, when the original pixel data RGB having a gradation of 122 is applied, the gradation code conversion unit 630 checks that the gradation of 122 is a value between the gradation points 112 and 128. Then, a variable gradation code data change rate (a first variable change rate) between the gradation points 112 and 128 in the point data group is calculated, and a reference gradation code data change rate (a first reference change rate) between the gradation points 112 and 128 in the reference gradation code data group is calculated. Also, a reference gradation code data change rate (a second reference change rate) between the gradation points 112 and 122 is calculated. Then, variable gradation code data corresponding to the gradation of 122 is calculated based on the first and the second reference change rates and the first variable change rate. In this case, a variety of interpolations may be used to calculate the reference gradation code data.

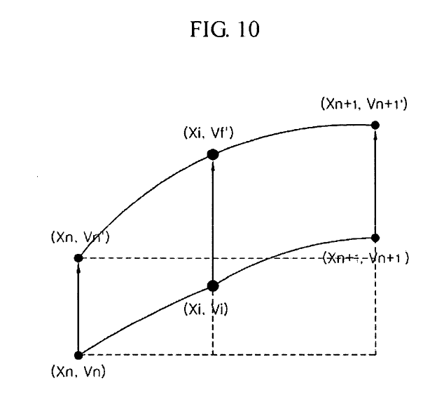

FIG. 10 is a diagram for calculating variable gradation code data that is not stored in a storage unit.

Referring to FIG. 10, Xn and Xn+1 are stored gradation points, Vn and Vn+1 are stored reference gradation code data corresponding to Xn and Xn+1, and Vn′ and Vn+1′ are stored variable gradation code data corresponding to Xn and Xn+1. Xi indicates a gradation of the input original pixel data RGB, Vi indicates stored reference gradation code data corresponding to Xi, and Vf indicates non-stored variable gradation code data corresponding to Xi.

The non-stored Vf can be calculated by Equation 1:

$$( {V}_{n + 1} - {V}_{n} ) \text{:} ( {V}_{i} - {V}_{n} ) = ( {V}_{n + 1}^{′} - {V}_{n}^{′} ) \text{:} ( {V}_{f} - {V}_{n}^{′} ) \\ \frac{( {V}_{f} - {V}_{n}^{′} )}{( {V}_{n + 1}^{′} - {V}_{n}^{′} )} = \frac{( {V}_{i} - {V}_{n} )}{( {V}_{n + 1}^{′} - {V}_{n}^{′} )} \\ {V}_{f} = \frac{( {V}_{i} - {V}_{n} )}{( {V}_{n + 1}^{′} - {V}_{n}^{′} )} \times ( {V}_{n + 1}^{′} - {V}_{n}^{′} ) + {V}_{n}^{′} \qquad Equation 1$$

For example, when the reference gradation code data stored for the gradations of 12 and 128 are 2565 and 2650, respectively, the variable gradation code data stored for the gradations of 112 and 128 are 2725 and 2825; and when the reference gradation code data stored for the gradation of 122 is 2625, the variable gradation code data calculated for the gradation of 122 is about 2795.

In this exemplary embodiment, the gradation code conversion unit 630 calculates variable gradation code data values other than variable gradation code data corresponding to the stored gradation point using the reference gradation code data and the stored variable gradation code data. Accordingly, variable gradation code data can be obtained without storing all variable gradation code data in the storage unit 620. This can minimize the luminance difference between the normal operation mode and the impulse operation mode without requiring an increase in the capacity of the storage unit 620.

That is, if all the reference gradation code data and all the variable gradation code data are stored in the storage unit, the necessary bytes are determined as follows. First, 257 bytes are required for storing the gradation code data. The gradation code data are required for the red, green and blue colors. The gradation code data further requires two values, that is, upper and lower values for the inversion operation. Accordingly, the normal operation requires 1542 bytes (257×3×2). One additional gradation code data group used in the impulse operation is also required. Accordingly, a total of 3084 bytes (1542×2) are required for storing all the reference gradation code data and all the variable gradation code data. This increases the required memory capacity of the storage unit 620, that is, the number of EEPROMs, and a manufacturing cost of the display device. On the other hand, this exemplary embodiment of the present invention requires a memory capacity of only 204 bits (12 bits×17), that is, about 25 bytes, because all the gradation code data in the gradation code data group used in the impulse operation are not stored in the storage unit 620 but just some of them, for example, only seventeen gradation code data values, are stored. Accordingly, in this exemplary embodiment, all the reference gradation code data and all the variable gradation code data can be generated with only the memory capacity of 1567 bytes (1542+25). Furthermore, if the impulse operation mode is divided into sub modes, a storage unit 620 having a much higher capacity is required. Whereas an increase of a memory capacity can be minimized if the variable gradation code data corresponding to the gradation point are stored as described in this exemplary embodiment.

The gradation code conversion unit 630, which performs the aforementioned operation, includes a gradation code signal generator 631 and a code data converter 632, as shown in FIG. 3. The code data converter 632 outputs the reference gradation code data corresponding to the gradation of the original pixel data RGB in the plurality of reference gradation code data groups stored in the storage unit 620 in response to the driving signal DIMP having the first or second level, or the variable gradation code data corresponding to the gradation of the original pixel data RGB using the plurality of reference gradation code data and some of the variable gradation code data stored in the storage unit 620. The gradation code signal generator 631 converts the original pixel data RGB into reference gradation code data or variable gradation code data corresponding thereto, thereby Outputting the gradation code signal C-RGB of the first and second levels.

The aforementioned gradation code conversion unit 630 is not limited to the above described construction, but may include a gradation code generator 633 and a code data changer 634 as in the exemplary embodiment shown in FIG. 4. The gradation code generator 633 converts the gradation of the original pixel data RGB into reference gradation code data corresponding thereto, and outputs the reference gradation code data as the gradation code signal C-RGB of the first level. The code data changer 634 outputs the gradation code signal C-RGB of the first level as it is in response to the first driving signal DIMP, or changes the gradation code signal C-RGB of the first level into the gradation code signal C-RGB of the second level based on the driving signal DIMP of the second level and the some variable gradation code data stored in the storage unit 620.

In the exemplary embodiment shown in FIG. 5, the gradation code conversion unit 630 may include a normal code signal generator 635 and a modified code signal generator 636. The normal code signal generator 635 converts the original pixel data RGB into the reference gradation code data corresponding to the gradation of the original pixel data RGB according to the driving signal DIMP of the first level, and outputs the reference gradation code data as the gradation code signal C-RGB of the first level. The modified code signal generator 636 generates variable gradation code data corresponding to the gradation of the original pixel data using the stored reference gradation code data and some of the variable gradation code data according to the driving signal DIMP of the second level, and outputs the generated variable gradation code data as the gradation code signal C-ROB of the second level. The single modified code signal generator 636 has been illustrated in the above variant, however, the present invention is not limited thereto, but there may be a plurality of modified code signal generators. That is, if the display device has a plurality of impulse operation modes, a plurality of the modified code signal generators corresponding to the respective impulse operation modes may be provided.

The gradation code signal C-RGB output from the gradation code conversion unit 630 is provided to the data Output unit 640 shown in FIG. 2.

The data output unit 640 provides the gradation code signal C-RGB to the data driver 300. In this case, the data Output unit 640 provides the gradation code signal C-RGB to the data driver 300 shown in FIG. 1 in a point to point differential signal (PPDS) manner.

In this exemplary embodiment, the signal controller 600 having the aforementioned configuration is manufactured in the form of an IC chip. The present invention is not limited to this exemplary embodiment, and the storage unit 620 may not be provided in the form of an IC chip within the signal controller 600 but may be manufactured as a separate IC chip. That is, the storage unit 620 may be fabricated in the form of a memory chip and then connected to the signal controller 600 on the circuit board.

The data driver 300 converts the applied gradation code signal C-RGB into the corresponding gradation voltage, and then provides the converted gradation voltage as the pixel data signal to the data lines D1 to Dm.

Hereinafter, the data driver 300 will be described in greater detail with reference to FIG. 6.

The data driver 300 includes a shift register 310, a data register 320, a latch 330, a gradation voltage generator 340, a digital-to-analog converter (DAC) 350, and an output buffer 360.

The shift register 310 generates a sampling signal based on the control signal from the signal controller 600. The shift register 310 supplies the generated sampling signal to the latch 330. The data register 320 temporarily stores the gradation code signals C-RGB that are sequentially input from the signal controller 600. The latch 330 samples and latches the gradation code signals C-RGB temporarily stored in the data register 320, in correspondence to the sampling signal from the shift register 310. In this case, the latch 330 simultaneously latches and outputs gradation code signals C-RGB corresponding to the respective data lines D1 to Dm shown in FIG. 1.

The gradation voltage generator 340 includes a voltage divider (not shown), and divides the plurality of reference gradation voltages VGref1 to VGrefn to generate a plurality of gradation voltages using the voltage divider. The gradation voltage generator 340 generates a plurality of gradation voltages through voltage division by a string of resistors, however, the present invention is not limited thereto. That is, the gradation voltage generator 340 may generate the plurality of gradation voltages corresponding to the 256 gradations using the reference gradation voltages VGref1 to VGrefn. For example, the gradation voltage generator 340 may generate the plurality of gradation voltages using the charging and discharging of a capacitor.

The digital-to-analog converter 350 converts the gradation code signal C-RGB output from the latch 330 into an analog pixel data signal using the plurality of gradation voltages from the gradation voltage generator 340. The digital-to-analog converter 350 outputs the converted pixel data signal to the output buffer 360. The output buffer 360 samples and holds the pixel data signal. The output buffer 360 outputs the pixel data signal to the data lines D1 to Dm shown in FIG. 1.

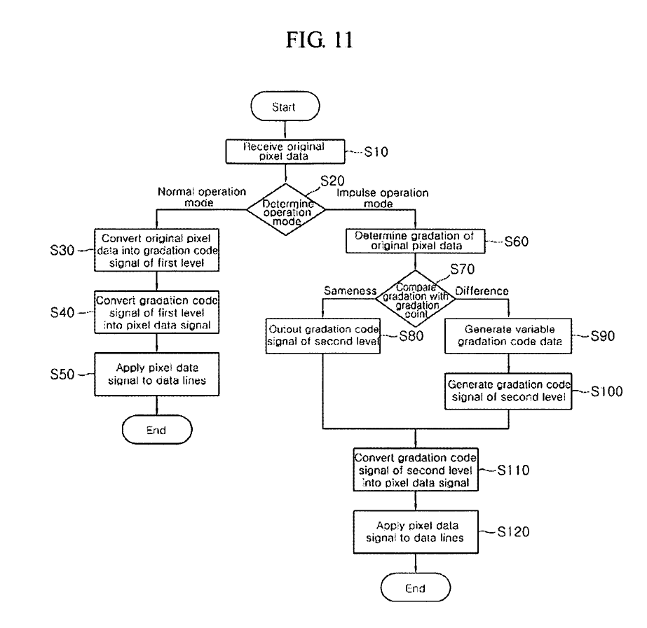

FIG. 11 is a flow chart illustrating the operation of the display device according to this exemplary embodiment.

Referring, to FIG. 11, the original pixel data RGB and a plurality of external control signals are first received (S10). An operation mode of the display device is then determined (S20). That is, a determination is made as to whether the display device is in the normal operation mode or the impulse operation mode based on a level of the driving signal DIMP of the external control signals.

If it is determined that the display device is in the normal operation mode, the original pixel data RGB is converted into the gradation code signal C-RGB of the first level using the reference gradation code data group (S30). For the conversion, the gradation of the original pixel data RGB is first determined. The reference gradation code data corresponding to the gradation of the original pixel data RGB in the reference gradation code data group stored in the storage unit 620 is output as the gradation code signal C-RGB of the first level. The gradation code signal C-RGB of the first level is then converted into the pixel data signal (S40). The pixel data signal is applied to the data lines D1 to Dm (S50).

If it is determined that the display device is in the impulse operation mode, the gradation of the original pixel data RGB is determined (S60). At this time, the level of the impulse operation mode is determined. The impulse operation mode has a plurality of levels depending on a percentage of black data in one frame. For example, as shown in FIG. 7, the display device of this exemplary embodiment has the first to third impulse operation modes. Thus, since there are a variety of levels of the impulse operation mode, variable gradation code data corresponding to the stored gradation points are diverse. Accordingly, in this exemplary embodiment, if it is determined that the display device is in the impulse operation mode as a result of the operation mode determination the variable gradation code data is selected depending on the level of the impulse operation mode. At this time, the variable gradation code data of a variety of levels are stored together with the reference degradation code data in the storage unit in which they are stored.

Then, the gradation of the original pixel data RGB is compared with the stored gradation point for equality (S70). If the gradation is the same as the stored gradation point value, variable gradation code data corresponding to the stored gradation point is output as the gradation code signal C-RGB of the second level (S80). If the gradation is not the same as the stored gradation point value as a result of the comparison, two upper and lower gradation points adjacent to the gradation are set. The variable gradation code data corresponding to the gradation is calculated based on two variable gradation code data corresponding to the two set adjacent gradation points, two reference gradation code data corresponding to the two set adjacent gradation points, and reference gradation code data corresponding to the gradation of the original pixel data (S90). The calculated variable gradation code data is output as the gradation code signal C-RGB of the second level (S100). The gradation code signal C-RGB of the second level generated according to the aforementioned manner is converted into a pixel data signal (S110). The pixel data signal is applied to the data lines D1 to Dm (S120).

As described above, according to the exemplary embodiments of the present invention, original pixel data are converted into gradation code signals C-RGB of different levels according to an image display mode, thereby luminance degradation and flicker generation according to the image display manner can be prevented.

Further, according to the exemplary embodiments of the present invention, in the normal operation, the gradation code signal of one level for all gradations can be generated using the stored reference gradation code data, and in the impulse operation, the variable gradation code signal corresponding to the gradation of the input original pixel data can be generated using some of the variable gradation code data corresponding to the stored the gradation points and the stored reference gradation code data.

Furthermore, in the exemplary embodiments of the present invention, only the reference gradation code data and some of the variable gradation code data are stored in the memory to thereby reduce the amount of data stored in the memory, so that an increase of manufacturing costs caused by additional memories can be prevented.

Although the present invention has been described in connection with the accompanying drawings and the exemplary embodiment, the present invention is not limited thereto but is otherwise defined by the appended claims. Accordingly, it will be understood by those of ordinary skill in the art that various modifications and changes can be made thereto without departing from the spirit and scope of the invention defined by the appended claims.

What is claimed is:

1. A display device, comprising:
a storage unit for storing a plurality of reference gradation code data corresponding to a plurality of gradations, and for storing some variable gradation code data corresponding to some gradation points of the plurality of gradations;
a signal controller for converting gradations of original pixel data into gradation code signals of different levels selectively using the plurality of reference gradation code data or using both the plurality of reference gradation code data and the some variable gradation code data according to an operation mode;
a data driver for converting the gradation code signal into an analog pixel data signal; and
an image display unit for displaying an image according to the analog pixel data signal.

2. The display device as claimed in claim 1, wherein the signal controller comprises:
a data input unit for receiving the original pixel data;
a gradation code conversion unit for converting the received original pixel data into the gradation code signal of a first or second level using the plurality of reference gradation code data and the some variable gradation code data according to the operation mode of the image display unit; and
a data output unit for providing the gradation code signal of the first or second level to the data driver.

3. The display device as claimed in claim 2, wherein the reference gradation code data and the variable gradation code data are selected from the same range of gradation code data values; and for the original pixel data having the same gradation, a gradation code data value of the gradation code signal of the second level is greater than a gradation code data value of the gradation code signal of the first level.

4. The display device as claimed in claim 2, wherein the gradation code conversion unit comprises:
a code signal converter for outputting the reference gradation code data corresponding to the gradation of the original pixel data among the plurality of reference gradation code data, or generating the variable gradation code data corresponding to the gradation of the original pixel data using the plurality of reference gradation code data and the some variable gradation code data, according to the operation mode of the image display unit; and
a gradation code signal generator for outputting the reference gradation code data or the variable gradation code data as the gradation code signal of the first or second level.

5. The display device as claimed in claim 2, wherein the gradation code conversion unit comprises:
a gradation code generator for converting the gradation of the original pixel data into the reference gradation code data; and
a code data changer for outputting the reference gradation code data as the gradation code signal of the first level, or converting the gradation code signal of the first level into the gradation code signal of the second level based on the variable gradation code data and outputting the gradation code signal of the second level, according to the operation mode of the image display unit.

6. The display device as claimed in claim 2, wherein the gradation code conversion unit comprises:
a normal code signal generator for outputting the reference gradation code data as the gradation code signal of the first level according to the operation mode of the image display unit, the reference gradation code data corresponding to the gradation of the original pixel data among the plurality of reference gradation code data; and
a modified code signal generator for generating the variable gradation code data corresponding to the gradation of the original pixel data using the plurality of reference gradation code data and the some variable gradation code data according to the operation mode of the image display unit, and outputting the generated variable gradation code data as the gradation code signal of the second level.

7. The display device as claimed in claim 1, wherein the operation mode of the image display unit is a normal operation mode or an impulse operation mode, and in the impulse operation mode, the signal controller provides a portion of a pixel data signal corresponding to a predetermined percentage of black in one frame section.

8. The display device as claimed in claim 7, wherein for the gradation of the same original pixel data, a level of the gradation code signal in the impulse operation mode is higher than a level of the gradation code signal in the normal operation mode.

9. The display device as claimed in claim 8, wherein the level of the gradation code signal increases as a percentage of the pixel data signal corresponding to the black applied in one frame section increases.

10. The display device as claimed in claim 1, wherein the storage unit and the signal controller are constructed in a single chip.

11. The display device as claimed in claim 1 wherein the data driver comprises:
a latch for latching the gradation code signal;
a gradation voltage generator for generating a plurality of gradation voltages; and
a digital-to-analog converter for converting the gradation code signal into the analog pixel data signal using the plurality of gradation voltages.

12. A method for driving a display device, comprising:
storing a plurality of reference gradation code data corresponding to a plurality of gradations and some of variable gradation code data corresponding to some gradation points of the plurality of gradations;
receiving original pixel data;
determining whether the display device is in a normal operation mode or an impulse operation mode; and
if the display device is in the normal operation mode, outputting the reference gradation code data, which corresponds to the gradation of the original pixel data among the plurality of reference gradation code data, as a gradation code signal of a first level, and if the display device is in the impulse operation mode, generating variable gradation code data corresponding to the gradation of the original pixel data using the plurality of reference gradation code data and the some variable gradation code data and outputting the generated variable gradation code data as the gradation code signal of a second level; and
converting the gradation code signal of the first or second level into a pixel data signal.

13. The method as claimed in claim 12, wherein the impulse operation mode is divided into a plurality of levels depending on a percentage of black data in one frame,
a plurality of variable gradation code data groups are stored to correspond to the plurality of levels of the impulse operation mode, the some variable gradation code data being stored in the variable gradation code data groups, and
when an impulse operation mode corresponding to one of the levels is selected, a corresponding variable gradation code data groups is used.

14. The method as claimed in claim 12, wherein storing the some variable gradation code data comprises:
generating the variable gradation code data corresponding to the plurality of gradations;
selecting some gradation points of the plurality of gradations; and
storing the selected gradation points and the some variable gradation code data corresponding thereto.

15. The method as claimed in claim 12, wherein generating the variable gradation code data corresponding to the gradation of the original pixel data using the plurality of reference gradation code data and the some variable gradation code data comprises:
comparing the gradation of the original pixel data with the some stored gradation points; and
using the stored variable gradation code data corresponding to the gradation of the original pixel data as it is if the gradation of the original pixel data is the same as the gradation points, and generating new variable gradation code data if the gradation of the original pixel data is not the same as the gradation points, and
wherein generating the new variable gradation code data comprises:
setting two upper and lower gradation points adjacent the gradation of the original pixel data; and
calculating the new variable gradation code data using the two variable gradation code data corresponding to the two adjacent gradation points, two reference gradation code data corresponding to the two adjacent gradation points, and reference gradation code data corresponding to the gradation of the original pixel data.

16. The method as claimed in claim 15, wherein the new variable gradation code data is calculated by interpolation.
